(19) United States
(12) Patent Application Publication
(10) Pub. No.: US 2007/0006644 A1
(43) Pub. Date: Jan. 11, 2007

(54) Continuous web stress distribution measurement sensor

(75) Inventor: Fred J. Schultheis, Knoxville, TN (US)

Correspondence Address: William F. Lang, IV;Eckert Seamans Cherin & Mellott, LLC, 44th Floor, 600 Grant Street, Pittsburgh, PA, 15219, US

(73) Assignee: ALCOA INC., Pittsburgh, PA (US)

(21) Appl. No.: 11/175,628

(22) Filed: Jul. 6, 2005

(51) Int. Cl. G01L 5/04

(52) U.S. Cl. 73/159

(57) ABSTRACT

A pressure sensor is wound in a helical pattern around a roller for providing a continuous measurement of the stress distribution within a material passing over the roller. The sensor may be a fluid filled tube having a pressure sensor at one end, or may be a piezoelectric ribbon. As the material passes over the roller, it is always applying pressure to one portion of the sensor. By monitoring the angular position of the roller, the points at which stress is being measured across the width of the material is known. The stress distribution may then be used to determine the flatness of the material passing over the roller.

### BACKGROUND OF THE INVENTION

1. Field of the Invention

The present invention relates to measurements of the stress applied by a web of material passing over a roller. More specifically, the invention provides an apparatus and method for providing a substantially continuous measurement of the stress applied to various portions of the material across the roller, while determining where across the width of the web of material the stress is being applied.

2. Description of the Related Art

When forming materials such as metal into sheets, for example, within a rolling mill, the flatness of the resulting material must be monitored. Various systems for monitoring this flatness, possibly through the tension the material applies to the last roller at the exit of the rolling mill, have been proposed.

For example, U.S. Pat. No. 2,189,609, issued to G. P. Lessmann on Feb. 6, 1940, discloses a fluid-pressure operated tensionmeter for maintaining a predetermined tension on material which is passing through the roll stands of the tandum rolling unit. The invention includes an idler roller mounted on one end of the bell crank lever, with the other end of the lever arm being attached to a fluid-pressure operated piston. The pressure in the cylinder housing the piston is maintained by spring-loaded diaphragm type fluid pressure regulating valve. The pressure maintained by the valve can be varied by an electrically energized solenoid disposed to counteract the spring in the regulating valve. The current in the solenoid may be set manually by a rheostat, or automatically by a vibrating or other suitable regulator. While the tensionmeter provides a means of maintaining a predetermined tension on material, it does not provide a means of measuring the tension applied by the material.

U.S. Pat. No. 3,324,695, issued to O. Sivilotti on Jun. 13, 1967, discloses a device for controlling the tension distribution across a strip within a roll mill. The device includes a helical sensor located around a billy roller, which does not complete a turn around the roller, to avoid any point on the rotation of the billy roll where the pressure sensitive zone can be located at more than one place at the same time. The sensor is in the form of a helical groove formed in the surface of the roll. The groove has a constant pitch. The groove may contain one or several transducers connected in series. The transducer provides an electrical output proportional to mechanical force to which it is subjected. The output of the transducer is therefore proportional to the pressure of the strip against the roller within the area of the sensor. The transducers are constructed of magnetostrictive material defining holes therein through which an excitation coil and a measuring winding may be wind. The excitation coil is connected to a current source, and the measuring winding is connected to a measuring instrument. The signal may be sent to a cathode ray oscillograph which indicates how the strip tension varies along the width of the strip. A means for manual adjustment of the strip width and thickness are provided to produce a signal corresponding to the value which the local strip tension would have if the strip were of equal thickness. This device does not provide continuous measurements, because the sensor does not complete a turn around the roller. Furthermore, the use of multiple transducers increases the costs of the device.

U.S. Pat. No. 3,481,194, issued to O. G. Sivilotti et al. on Dec. 2, 1969, discloses a strip flatness sensor. The flatness sensor includes the plurality of pressure sensitive transducers, with each transducer being located within one axially situated section defined on a billy roll. Each transducer is made from a magnetostrictive material having an excitation winding and a measuring winding. The excitation winding is connected to slip rings, with an excitation current source connected to the slip rings through brushes. By connecting the adjacent tranducers in series, and locating the transducers within adjacent sections approximately 180° apart, any error signals will cancel each other out. The section may have up to eight pressure sensitive zones, provided that the zones are far enough apart so that a strip may not act on two sensors within the section at once. This sensor does not provide continuous measurements across the width of the web of material.

U.S. Pat. No. 3,688,571, issued to A. G. Atkins et al. on Sep. 5, 1972, describes an apparatus for determining flatness deviation in a sheet or strip. The apparatus includes an exit bridle roll, and includes five compression type load cells mounted inside the roll. A transfer pin extends from each load cell through a hole in the shell of the roll, protruding beyond the surface of the roll very slightly to contact the underside of a thin rubber sleeve covering the roll. The roll includes a shaft having a timer assembly on one end and a slip ring assembly on the other end. The timer assembly includes a set of contacts which are closed by a cam when the pins arrive at a point where the strip makes contact with the roll, until the pins arrive at a point where the strip leaves contact with the roll. The strip includes loose or overrolled sections, which will carry less of the normal reaction tensile loading on the exit bridle roll than tight or underrolled sections. As the strip passes over the pins, the differences in tensile loadings across the face of the roll produce different signals, which may be recorded on a display unit. This apparatus requires multiple sensors, and does not provide continuous measurements across the width of the material.

U.S. Pat. No. 4,428,244, issued to Y. Takeda on Jan. 31, 1984, discloses an apparatus for measuring internal stress of the strip during a rolling process. The apparatus includes a segmented roll, with a plurality of ring-shaped stress detection mechanisms with small gaps therebetween. Gas is supplied through a gas supply pipe and emitted from the small gaps between the ring-shaped stress detection mechanisms. The water supply mechanism ejects water to cool the necessary portions of the work rolls to make the distribution of stress within a strip passing over the work rolls uniform. The gas passing into the gaps prevents rolling oil from entering the gaps. The detected stress is transmitted to a control apparatus. This apparatus does not provide continuous measurements of the stress distribution across the width of the material.

U.S. Pat. No. 5,089,776, issued to T. Furukawa et al. on Feb. 18, 1992, discloses an apparatus for detecting defects in a moving steel strip. The apparatus includes a pair of nonmagnetic cylinders which pinch a running steel strip therebetween. One cylinder contains a magnetic yoke having a magnetizing coil. The opposing cylinder includes at least one sensor placed near the pinched strip. Applied tension on the strip and the weight of the strip act on the cylinder which encloses the magnetizing yoke. The thickness of this cylinder can be increased by increasing the magnetizing power. No significant force is designed to be applied from the cylinder enclosing the sensor unit. Therefore, this cylinder may be made thin to maximize the accuracy of the sensor. The thickness of that portion of the cylinder under the magnetic detecting elements can be made thinner than the portions of the cylinder between the magnetic detecting elements without affecting the structural strength of the cylinder. The cylinders are made from a nonmagnetic material having high electric resistance. This apparatus is therefore directed towards detecting surface defects within the strip, as opposed to detecting the flatness of the strip.

U.S. Pat. No. 5,379,631, issued to Y. Kira et al. on Jan. 10, 1995, discloses a flatness detector. The flatness detector includes a shaft surrounded by a plurality of rings in close contact with each other, and coupled to a pressure sensor. Compressed air supplied through holes within the shaft provides a gap between the shaft and the rings. The plurality of through-holes extending through the shaft are in communication with the pump for supplying a liquid heating medium therethrough. The detector further includes a support and a bending bolt at each side of the shaft, with the support structured to support the shaft at a side opposite the direction of bending, and the bending bolt disposed outwardly of and at a side opposite to the support for exerting pressure to the shaft to bend the shaft. In use, the shaft will be bent in a convex form towards a strip of material passing over it, so that different tensions are exerted to the middle of the strip and the side edges of the strip. This difference in tension prevents the formation of length-wise wrinkles during the flatness measurement. This flatness detector fails to provide continuous detection of flatness across the width of the material. It may only detect flatness across as many intervals as it has rings surrounding the shaft.

U.S. Pat. No. 5,964,114, issued to R. Noé et al. on Oct. 12, 1999, describes a method of regulating the stress distribution in non-ferromagnetic metals. Profile or contour measuring units, which may be optical or mechanical, provide information about the metal strip. These signals are evaluated, and corresponding signals are generated for operating stators. The stators may be located on either side of the metal strip, and may be selectively oriented, and current passed through them in a selected direction, to reduce or enhance the various stresses within the metal strip to produce a flat strip. This method is therefore directed more towards changing the stresses within a metal strip once they are detected, as opposed to detecting the stresses.

U.S. Pat. No. 6,035,259, issued to E. A. Graff et al. on Mar. 7, 2000, describes a web material camber measurement apparatus and method. The measurement method is based on the curvature in the metal strip caused by differences in tension within the strip. The curvature is measured by a tensioning measuring apparatus or load cell. The load cell includes a base plate mounted to a fixed frame, with the load frame supported above the base plate by a spring therebetween. A converter apparatus and signal conditioner convert the mechanical position of the load frame to an electrical signal. As the material is conveyed above the conveyance roller mounted on the load frame, it displaces the load frame, thereby providing a measure of tension within the material. This measurement apparatus fails to provide continuous measurements of stress distribution across the web of material, relying instead on the difference in the pressure applied along each side of the material.

U.S. Pat. No. 6,164,104, issued to R. Noé et al. on Dec. 26, 2000, describes a method and apparatus for measuring the planarity of a metal strip. A measuring device such as a CCD camera, a laser optic distance measuring device, an inductive or capacitor sensor, or other sensor, is used to measure the planarity of a strip of metal passing through a series of rollers. Controlled braking of the strip is provided by stators based on the measurements of planarity. All of these methods of measuring the planarity of the strip are expensive.

U.S. Pat. No. 6,216,505, issued to S. Hiramatsu et al. on Apr. 17, 2001, describes a method and apparatus for rolling a strip. The apparatus includes a pair of back-up rolls, with one back-up roll having a single oil chamber, and the other back-up roll having a plurality of oil chambers. Pressing-down balancers, each of which is driven independently, are located at both ends of the roll shaft of the back-up roll. Roll benders are located between the roll shafts of the opposing work rolls. The calculation and control unit reads signals generated by a shape meter, and adjust the pressing-down balancers and roll benders accordingly. This method therefore relies on expensive equipment to detect the shape of the strip.

U.S. Pat. No. 6,494,071, issued to T. Norikura on Dec. 17, 2002, discloses a rolling mill facility with a strip-shape detection device. Load cells on each side of the roller measure the force applied by the metal strip to that side of the roller. The supporting reaction forces within the load cells are detected. Shape of the metal strip, and therefore the tension distribution within the strip, can then be calculated. A gap sensor may be provided on the lower side of the mid-point of the roller, for measuring the deflection of the mid-point of roller. This detection device therefore does not provide continuous measurements of stress distribution across the entire width of the roller, relying instead on the end points and the midpoint of the metal strip.

Some of the above-described means of measuring the tension or flatness of a strip of material passing across a roller do not provide continuous measurements. Others require complicated, expensive equipment. The continuous measurement of the stress distribution across the entire web of material, and the corresponding information about the flatness of the material, is important both for quality control purposes and to maximize the throughput of a rolling mill used to produce the strip of material. Accordingly, a continuous means of measuring stress distribution across the web of material, being simplier and less expensive than presently available sensors, is desired.

### SUMMARY OF THE INVENTION

The present invention provides a continuous measurement of the stress applied by a web of material passing over a roller, thereby providing an indication of the flatness of the material. The sensor is wound at a helical pattern one complete turn around the roller, so that, as the material passes over the roller, at least one portion of the sensor is acted upon by the material. This information is combined with the angular position of the roller to determine the portion of the sensor being acted upon by the material. Both the stress applied by the material and the location at which that stress is applied are therefore both known.

In one embodiment of the invention, the sensor may be a fluid filled tube. As the material passes over the roller, it applies pressure to one point on the tube. These changes in pressure can be measured by a pressure sensor at one end of the tube. A resolver may be used to monitor the angular position of the roller. The fluid-filled tube combined with the pressure sensor will therefore monitor the pressure applied by the strip of material upon the roller, while the resolver may provide information about the angular position of the roller, and therefore, the position across the width of the strip of material at which the pressure is being applied.

Alternatively, the sensor may be a piezoelectric, piezoresistive, or similar strip or ribbon. As the material passes over the roller, it applies pressure to the portion of the piezoelectric strip. When pressure is applied to a piezoelectric material, an electrical current is formed therein. The voltage and/or amperage of this current may be measured, thereby providing an indicia of the changes in tension applied by the strip of material upon the roller. Again, by monitoring the angular position of the roller, for example, by a resolver, the position across the width of the material at which the pressure is being applied can be determined.

Regardless of whether the sensor is a fluid filled tube or a piezoelectric strip or a ribbon, the number of sensors helically wrapped around the roller is not limited to one. Multiple sensors may be provided, with each sensor following a helical path that is substantially parallel to the adjacent sensors. The maximum limit to the number of sensors that may be used is the number that would completely cover the surface of the roller. Increasing the number of sensors provides more information about the stress distribution across the web of material, but would also result in increased cost.

As another alternative, multiple sensors may be connected end to end, and then positioned in a helical path around the roller, in a manner so that no single sensor crosses any given angular position of the roller more than once, but the strain of end to end sensors crosses each angular position at several different locations across the width of the roller. This arrangement will provide additional information about the stress distribution across a web of material passing over the roller. The number of sensors that may be used may be increased up to the point where the entire roller is covered with sensors.

The present invention therefore provides a continuous means of measuring the stress distribution across a web of material being pulled across a roller. The apparatus and method is simpler and less costly than prior art flatness and stress distribution sensors.

Accordingly, it is an object of the present invention to provide an apparatus for continuously measuring the stress distribution across a web of material passing over a roller.

It is another object of the invention to provide a helical pressure sensor wrapped around a roller so that, at any point in the rotation of the roller, stress is being measured at one point across the width of the material passing over the roller.

It is a further object of the invention to provide a continuous web stress distribution sensor in the form of a fluid filled tube with a pressure sensor at one end.

It is another object of the invention to provide a web stress distribution sensor in the form of a piezoelectric, piezoresistive, or silimar ribbon.

It is a further object of the invention to provide a method of measuring the stress distribution across a web of material passing across a roller, that is simpler and less costly than the prior methods.

It is another object of the invention to provide a simple, cost effective means of monitoring the flatness of material passing across a roller.

These and other objects of the invention will become more apparent through the following description and drawings.

### BRIEF DESCRIPTION OF THE DRAWINGS

FIG. 1 is an isometric view of a continuous web stress distribution sensor according to the present invention.

FIG. 2 is an isometric view of another embodiment of a continuous web stress distribution sensor according to the present invention.

FIG. 3 is a schematic view of a resolver.

FIG. 4 is an isometric view of yet another embodiment of a continuous web stress distribution system according to the present invention.

FIG. 5 is an isometric view of yet another embodiment of a continuous web stress distribution sensor according to the present invention.

Like reference characters denote like elements throughout the drawings.

### DETAILED DESCRIPTION OF THE PREFERRED EMBODIMENTS

The present invention provides a continuous sensor wound in a helical pattern around a roller, for measuring the stress within a web of material passing over the roller.

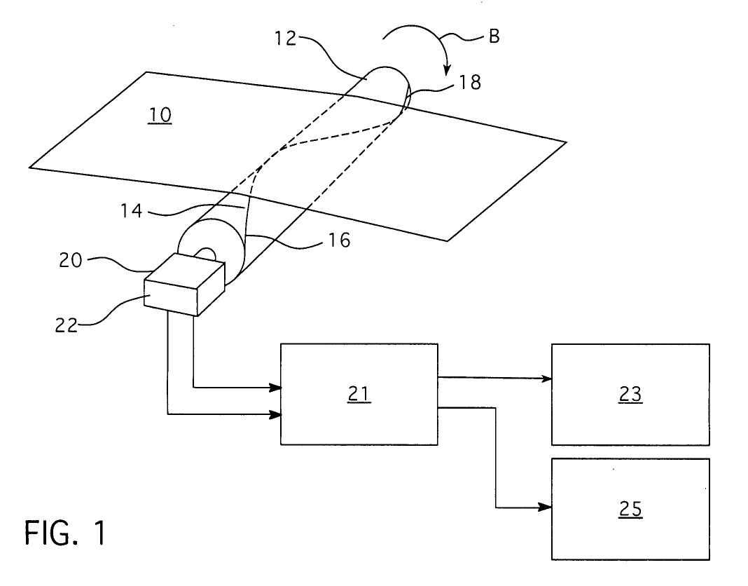

Referring to FIG. 1, the web of material 10 passing over a roller 12 is illustrated. The roller 12 may be, for example, the last roller of a rolling mill. The roller 12 includes a sensor 14 wound in a helical pattern around the roller 12. The sensor 14 includes a pair of ends 16, 18. The sensor 14 is preferably wrapped around the roller 12 so that, as the material 10 passes over the roller, it applies pressure at one point on the sensor, with the point at which pressure is applied moving from one end of the roller to the other. As the material 10 stops applying pressure at the end 18 of the sensor 14, it begins applying pressure at the end 16 of the sensor 14.

In the embodiment of FIG. 1, the sensor 14 is a fluid filled tube having a pressure sensor 20 at the end 16. The tube may be made from any flexible material that is compatible with the selected fluid, for example, vinyl, rubber, or synthetic rubber. The fluid may be any compressible fluid, for example, hydraulic fluid. Regardless of which portion of the sensor 14 is underneath the material 10, the pressure applied by the material to the roller 12 can be detected by the pressure sensor 20.

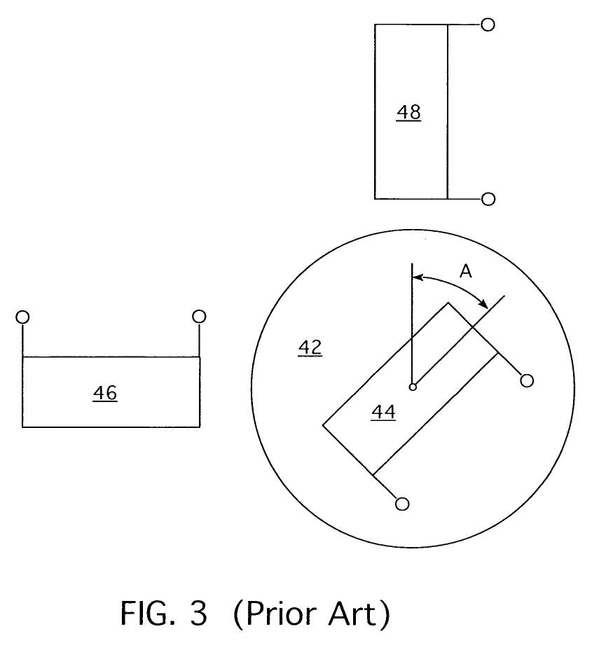

A resolver 22 is operatively connected with the roller 12, for monitoring the angular position of the roller 12. Resolvers 22 are well known in the art, and are therefore not described in extensive detail here. Referring to FIG. 3, in general, a resolver has a rotor 42 having a coil 44 through which a reference current is passed. A pair of stator coils 46, 48 are provided adjacent to the rotor 42, located about 90° from each other and having their axes oriented towards the center of the rotor 42. The rotor coil 44 and stator coils 46, 48 essentially function as a rotating transformer, with the reference signal inducing a current in each of the stator coils 44. The amplitude of the output of the stator coil 46 signal will vary according to the sine of the angle A of the rotor coil 44, and the amplitude of the signal from the stator coil 48 will vary according to the cosine of the angle A of the rotor coil 44. The angular position of the roller 12 may therefore be determined by the respective amplitudes of the signals from the stator coils 46,48. The document, Martin Staebler, TMS320F240 DSP Solution for Obtaining Resolver Angular Position and Speed (2000), describing resolver to digital conversion developed at Texas Instruments, describes the operation of resolvers in greater detail, and is hereby incorporated by reference. With the angular position of the roller known, the exact point at which pressure is being applied to the sensor can be determined.

The signal generated by the pressure sensor 20 will be proportional to the pressure applied by the web of material 10 to the roller 12. As the web of material 10 is pulled over the roller 12, the portion of the sensor being compressed will move from the end 16 to the end 18, in the direction of arrow B. The pressure applied by the web of material 10 to the roller 12 is thereby continuously measured as the point of measurement travels across the width of the web of material 10. The resolver 22 monitors the angular position of the roller 12, so that this information, combined with the knowledge of how the sensor 14 is wrapped around the roller 12, can be used to determine at which point across the width of the web of material 10 the pressure is being measured. The stress distribution across the web of material 10 may therefore be calculated by directing the signals from the sensor 20 and the resolver 22 to an appropriate microprocessor 21. The change in the pressure applied at different portions across the width of the web of material 10 exceeding a predetermined limitation provides an indication that the flatness of the web of material 10 is out of specification. The appropriate signal may then be sent to a display 23 or control system 25.

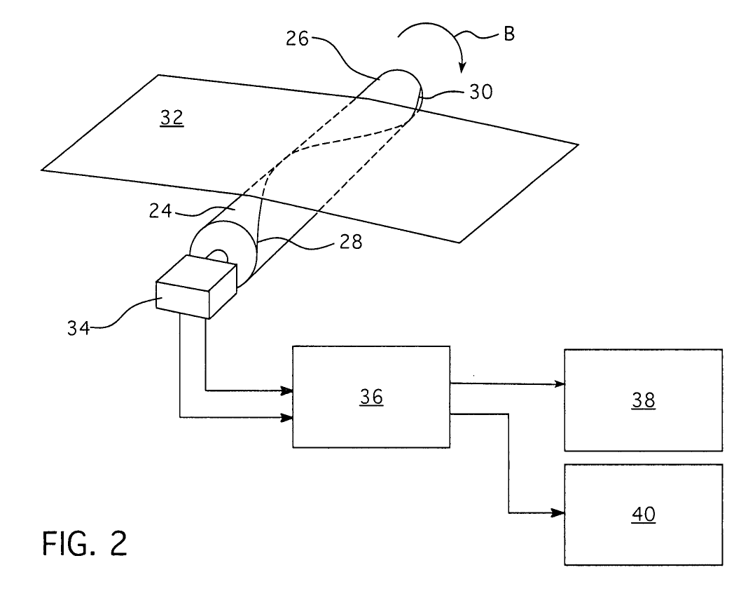

Referring to FIG. 2, an alternative embodiment of the sensor is illustrated. The sensor 24 is a piezoelectric, piezoresistive, or similar strip or ribbon wrapped in a helical pattern around the roller 26. As before, the sensor 24 has a pair of ends 28, 30, disposed on the roller 26 so that, as the web of material 32 stops applying pressure to the end 30, it begins applying pressure to the end 28. The roller 26 also includes a resolver 34 operatively connected to the roller 26, for monitoring the angular position of the roller 26. As the web of material 32 passes over the roller 26, it applies pressure to one portion of the sensor 24, generating an electrical current within the sensor.

As before, the signal generated by the sensor 24 will be proportional to the pressure applied by the web of material 32 to the roller 26. As the web of material 32 is pulled over the roller 26, the portion of the sensor being compressed will move from the end 28 to the end 30, in the direction of arrow B. The pressure applied by the web of material 32 to the roller 26 is thereby continuously measured as the point of measurement travels across the width of the web of material 32. The resolver 34 monitors the angular position of the roller 26, so that this information, combined with the knowledge of how the sensor 24 is wrapped around the roller 26, can be used to determine at which point across the width of the web of material 32 the pressure is being measured. The stress distribution across the web of material 32 may therefore be calculated by directing the signals from the sensor 24 and the resolver 34 to an appropriate microprocessor 36. The change in the pressure applied at different portions across the width of the web of material 32 exceeding a predetermined limitation provides an indication that the flatness of the web of material 32 is out of specification. The appropriate signal may then be sent to a display 38 or control system 40.

The present invention therefore provides two embodiments of a helical sensor for continuously monitoring the stress distribution applied by a web of material passing over a roller, providing a simple, economical means of monitoring the flatness of the material as it passes over the roller.

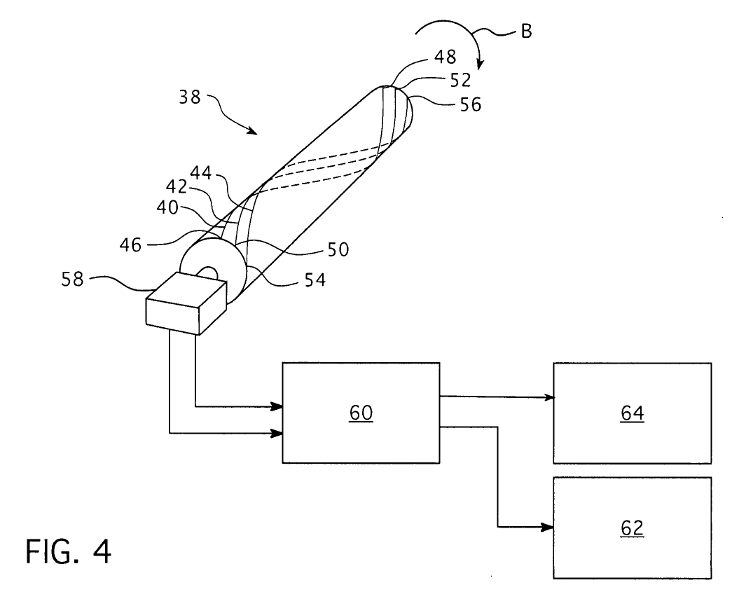

Referring to FIG. 4, a roller 38 having an alternative sensor configuration is illustrated. The roller 38 includes a plurality of sensors, with the illustrated example having three sensors 40, 42, 44. The sensor 40 has a pair of ends 46, 48. Likewise, the sensor 42 has a pair of ends 50, 52, and the sensor 44 has a pair of ends 54, 56. Each of the sensors 40, 42, 44 makes one complete loop around the roller 38. The sensors 40, 42, 44 may be fluid filled tubes as illustrated in FIG. 1, or piezoelectric, piezoresistive, or similar strips as illustrated in FIG. 2.

A resolver 58 is operatively connected with the roller 38, for monitoring the angular position of the roller 38. This information, along with the pressure being applied to the sensors 40, 42, 44, is sent to the microprocessor 60. The microprocessor utilizes the angular position of the roller 38 combined with information about how each of the sensors 40, 42, 44 is wrapped around the roller 38 to determine at which point across the width of a web of material passing over the roller 38 pressure is being measured by each of the sensors 40, 42, 44. A change in the pressure applied at different portions across the width of the web of material exceeding a predetermined limitation provides an indication of the flatness of the web of material is out of specification. The appropriate signal may then be sent to the display 62 or control system 64.

Although three sensors 40, 42, 44 are illustrated in FIG. 4, the number of sensors utilized may be increased until the entire surface of the roller 38 is covered if measurement requiring this number of sensors is desired.

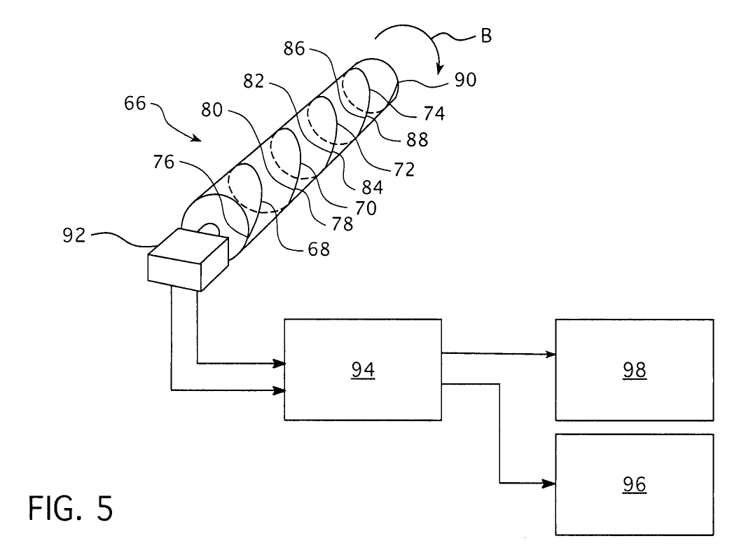

Referring to FIG. 5, yet another embodiment of the invention is illustrated. A roller 66 includes a plurality of sensors wrapped around the roller, with the sensors connected end to end. In the illustrated example, sensors 68, 70, 72, and 74 are illustrated. Sensor 68 extends between the ends 76, 78. Likewise, sensor 70 extends between the ends 80 and 82. Sensor 72 extends between the ends 84 and 86. Sensor 74 extends between the ends 88 and 90. Each of the sensors 68, 70, 72, 74 therefore makes one complete turn around the roll, with the string of sensors forming a helical pattern around the roll 66. Although the illustrated example includes four sensors, any number of sensors may be used up to and including the number that would be required to completely cover the roll 66. The sensors 68, 70, 72, 74 may be fluid filled tubes as illustrated in FIG. 1, or piezoelectric, piezoresistive, or similar strips as illustrated in FIG. 2.

A resolver 92 is operatively connected to the roller 66, for monitoring the angular position of the roller 66. This angular position, along with the pressure applied to each of the sensors 68, 70, 72, 74, is supplied to a microprocessor 94. The microprocessor 94 uses the angular position of the roller 66 combined with information about how each of the sensors 68, 70, 72, 74 is wrapped around the roller 66 to determine at which point across the width of a web of material passing over the roller 66 pressure is being measured by each of the sensors 68, 70, 72, 74. The change in the pressure applied at different portions across the width of the web of material exceeding a predetermined limitation provides an indication that the flatness of the web of material is out of specification. The appropriate signals may then be sent to a display 96 or control system 98.

While a specific embodiment of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A sensor for detecting a stress distribution within a strip of material passing over a roller, the sensor comprising:
a pressure sensing element wound in a helical pattern completely around the roller;
means for sensing an angular position of the roller; and
means for reading a signal generated by the pressure sensing element and calculating the pressure from a signal generated by the sensing element, and for determining the location at which the pressure is measured from the angular position of the roller.

2. The sensor according to claim 1, wherein the sensing element is a fluid-filled tube.

3. The sensor according to claim 2, further comprising a pressure sensor disposed at one end of the tube, in communication with the fluid therein.

4. The sensor according to claim 3, wherein the means for reading a signal generated by the pressure sensing element and calculating the pressure from a signal generated by the sensing element, and for determining the location at which the pressure is measured from the angular position of the roller, include a microprocessor structured to calculate the pressure from the signal generated by the pressure sensor, and the location of a portion of the tube upon which the material has impinged by determining the angular position of the roller through the signal generated by the means for sensing an angular position of the roller.

5. The sensor according to claim 1, wherein the sensing element is selected from the group consisting of piezoelectric and piezoresistive.

6. The sensor according to claim 5, wherein the means for reading a signal generated by the pressure sensing element and calculating the pressure from a signal generated by the sensing element, and for determining the location at which the pressure is measured from the angular position of the roller include a microprocessor structured to calculate the pressure from the signal generated by the piezoelectric sensor, and the location of a portion of the tube upon which the material has impinged by determining the angular position of the roller through the signal generated by the means for sensing an angular position of the roller.

7. The sensor according to claim 1, further comprising a plurality of pressure sensing elements wound in a helical pattern completely around the roller.

8. The sensor according to claim 7, wherein the plurality of pressure sensing elements are substantially parallel to each other.

9. The sensor according to claim 7, wherein the plurality of pressure sensing elements each include a pair of ends, the plurality of pressure sensing elements being arranged end to end to form a single helical sensor assembly.

10. The sensor according to claim 1, wherein the means for sensing the angular position of the roller include a resolver.

11. A method of measuring a stress distribution across a strip of material passing over a roller, the method comprising:
providing a sensing element wound in a helical pattern completely around the roller;
providing means for sensing an angular position of the roller;
providing means for reading a signal generated by the pressure sensing element and calculating the pressure from a signal generated by the sensing element, and for determining the location at which the pressure is measured from the angular position of the roller;
determining a relationship between the angular position of the roller and a location of a portion of the sensor being impinged by the strip of material;
reading a signal generated by the sensing element and a corresponding signal generated by the means for sensing an angular position of the roller;
calculating an amount of tension from the signal generated by the sensing element; and
calculating the location of the tension from the signal generated by the means for sensing an angular position of the roller.

12. The method according to claim 1:
wherein the sensing element is a fluid-filled tube having a pressure sensor at one end; and
further comprising the step of generating a signal from the pressure sensor based on changes in pressure within the tube.

13. The method according to claim 11:
wherein the sensing element is a piezoelectric strip; and
further comprising the step of producing an electrical signal within the strip resulting from pressure applied to the strip.

14. The method according to claim 11:
wherein the sensing element is a piezoresistive strip; and
further comprising the step of monitoring a change in a resistance of the piezoresistive strip resulting from pressure applied to the strip.
